(19) United States
(12) Patent Application Publication
(10) Pub. No.: US 2026/0116021 A1
(43) Pub. Date: Apr. 30, 2026

(54) METHODS OF FORMING A COMPOSITE STRUCTURE AND ASSOCIATED SYSTEMS AND MATERIALS

(71) Applicant: Northrop Grumman Systems Corporation, Falls Church, VA (US)

(72) Inventors: Christopher J. Madsen, Layton, UT (US); Charles Flackman, Roy, UT (US); Himler Michel, South Salt Lake, UT (US); Jason H. Stulp, Fruit Heights, UT (US); Ryan Thornburg, Ogden, UT (US); Travis S. Olsen, Tremonton, UT (US); Vernon M. Benson, Morgan, UT (US); Wesley Babilonia, Layton, UT (US)

(21) Appl. No.: 18/925,498

(22) Filed: Oct. 24, 2024

(51) Int. Cl. B29C 70/30; B29C 70/20; B29C 70/56; B29L 31/00

(52) U.S. Cl. CPC B29C 70/302; B29C 70/20; B29C 70/56; B29L 2031/7724

(57) ABSTRACT

A sheet of composite material sheet of composite material includes a backing material. The sheet of composite material further includes at least two non-rectangular segments of composite material on the backing material. A first non-rectangular segment of the at least two non-rectangular segments positioned adjacent to a second non-rectangular segment of the at least two non-rectangular segments.

### TECHNICAL FIELD

Embodiments of the disclosure generally relate to methods of forming a composite structure. In particular, embodiments of the disclosure relate to methods of forming composite structures and the associated structures, systems, tools, and materials.

### BACKGROUND

Composite layup processes may be used to form high-strength lightweight parts for complex structures, such as aircraft, automobiles, aircraft engines, turbines, etc. Composite layup processes involve laying up multiple layers or plies of a composite material to achieve a desired final thickness and shape of an associated composite structure. Many composite structures have complex shapes, such as frustoconical shapes, bi-conical shapes; spheroid shapes, etc., and/or combinations thereof.

In some cases, the layers or plies of the composite material may be formed by applying fiber over a mandrel in a winding process before applying a resin or matrix and then curing the material. In other cases, the layers or plies are formed by applying sheets of a composite material that include fiber suspended in a matrix or resin (e.g., prepreg) over a mandrel. For some complex shapes, portions of the sheet of composite material may stretch or drape relative to other portions to accommodate the different complex shapes.

### BRIEF SUMMARY

Some embodiments include a sheet of composite material. The sheet of composite material includes at least two non-rectangular segments of composite material. A first non-rectangular segment of the at least two non-rectangular segments positioned adjacent to a second non-rectangular segment of the at least two non-rectangular segments. The first non-rectangular segment coupled to the second non-rectangular segment along lateral edges of the first non-rectangular segment and the second non-rectangular segment.

Another embodiment of the disclosure includes a method of forming a composite structure. The method includes positioning non-rectangular segments of a composite material on a backing material in a curved arrangement. The method further includes applying the composite material to a mandrel. The method also includes removing the backing material.

Other embodiments of the disclosure include a system for forming a composite structure. The system includes a frame. The system further includes a mandrel having a substantially frustoconical shape including a small mandrel end and a large mandrel end defining a mandrel increase ratio, the mandrel coupled to the frame. The system also includes a composite material roll coupled to the frame adjacent the mandrel, the material roll including a sheet of composite material, the material roll having a second substantially frustoconical shape having a small material roll end and a large material roll end, defining a material roll increase ratio, the material roll increase ratio substantially matching the mandrel increase ratio.

### BRIEF DESCRIPTION OF THE DRAWINGS

While the specification concludes with claims particularly pointing out and distinctly claiming embodiments of the disclosure, the advantages of embodiments of the disclosure may be more readily ascertained from the following description of embodiments of the disclosure when read in conjunction with the accompanying drawings in which:

FIG. 1 illustrates a top view of a system for forming a composite structure in accordance with embodiments of the disclosure;

FIG. 2 illustrates a plan view of the system of FIG. 1;

FIG. 3A illustrates a schematic view of a forming tool in accordance with embodiments of the disclosure;

FIG. 3B illustrates a schematic view of a model of the forming tool of FIG. 3A;

FIG. 4 illustrates a sheet of composite material in accordance with embodiments of the disclosure;

FIG. 5 illustrates a process act for forming segments of the composite material of FIG. 4;

FIG. 6 illustrates a process act for forming segments of the composite material of FIG. 4;

FIGS. 7A-7C illustrate cross-sections of different embodiments of a joint between two segments formed in the process acts of FIGS. 5 and 6;

FIG. 8 illustrates a process act for forming segments of the composite material of FIG. 4;

FIG. 9 illustrates a schematic view of the composite material formed in the acts of FIGS. 5-8 being applied to the system of FIGS. 1 and 2;

FIG. 10 illustrates embodiments of a forming tool and composite sheet being applied to the forming tool;

FIG. 11 illustrates embodiments of a forming tool and composite sheet being applied to the forming tool;

FIGS. 12A-12C illustrate different embodiments of composite sheets formed in accordance with embodiments of the disclosure;

FIGS. 13A and 13B illustrate segments of composite material for forming the composite sheets of FIGS. 12A and 12B; and

FIG. 14 illustrates embodiments of a composite sheet formed in accordance with embodiments of the disclosure.

### DETAILED DESCRIPTION

The following description provides specific details, such as material compositions, shapes, and sizes, in order to provide a thorough description of embodiments of the disclosure. However, a person of ordinary skill in the art would understand that the embodiments of the disclosure may be practiced without employing these specific details. Indeed, the embodiments of the disclosure may be practiced in conjunction with conventional techniques employed in the industry.

Drawings presented herein are for illustrative purposes only, and are not meant to be actual views of any particular material, component, structure, device, or system. Variations from the shapes depicted in the drawings as a result, for example, of manufacturing techniques and/or tolerances, are to be expected. Thus, embodiments described herein are not to be construed as being limited to the particular shapes or regions as illustrated, but include deviations in shapes that result, for example, from manufacturing. For example, a region illustrated or described as box-shaped may have rough and/or nonlinear features, and a region illustrated or described as round may include some rough and/or linear features. Moreover, sharp angles that are illustrated may be rounded, and vice versa. Thus, the regions illustrated in the figures are schematic in nature, and their shapes are not intended to illustrate the precise shape of a region and do not limit the scope of the present claims. The drawings are not necessarily to scale. Additionally, elements common between figures may retain the same numerical designation.

As used herein, the terms “configured” and “configuration” refers to a size, a shape, a material composition, a material distribution, orientation, and arrangement of at least one feature (e.g., one or more of at least one structure, at least one material, at least one region, at least one device) facilitating use of the at least one feature in a pre-determined way.

As used herein, the term “substantially” in reference to a given parameter means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0 percent met, at least 95.0 percent met, at least 99.0 percent met, at least 99.9 percent met, or even 100.0 percent met.

As used herein, “about” or “approximately” in reference to a numerical value for a particular parameter is inclusive of the numerical value and a degree of variance from the numerical value that one of ordinary skill in the art would understand is within acceptable tolerances for the particular parameter. For example, “about” or “approximately” in reference to a numerical value may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

As used herein, relational terms, such as “beneath,” “below,” “lower,” “bottom,” “above,” “upper,” “top,” “lead,” “leading,” “trailing,” “left,” “right,” and the like, may be used for ease of description to describe one element's or feature's relationship to another element(s) or feature(s) as illustrated in the drawings. Unless otherwise specified, the spatially relative terms are intended to encompass different orientations of the materials in addition to the orientation depicted in the figures. For example, if materials in the figures are inverted, elements described as “below” or “beneath” or “under” or “on bottom of” other elements or features would then be oriented “above” or “on top of” the other elements or features. Thus, the term “below” can encompass both an orientation of above and below, depending on the context in which the term is used, which will be evident to one of ordinary skill in the art. The materials may be otherwise oriented (e.g., rotated 90 degrees, inverted, flipped) and the spatially relative descriptors used herein interpreted accordingly.

As used herein, the terms “vertical,” “longitudinal,” “horizontal,” and “lateral” are in reference to a major plane of a structure and are not necessarily defined by earth's gravitational field. A “horizontal” or “lateral” direction is a direction that is substantially parallel to the major plane of the structure, while a “vertical” or “longitudinal” direction is a direction that is substantially perpendicular to the major plane of the structure. The major plane of the structure is defined by a surface of the structure having a relatively large area compared to other surfaces of the structure. With reference to the drawings, a “horizontal” or “lateral” direction may be perpendicular to an indicated “Z” axis, and may be parallel to an indicated “X” axis and/or parallel to an indicated “Y” axis; and a “vertical” or “longitudinal” direction may be parallel to an indicated “Z” axis, may be perpendicular to an indicated “X” axis, and may be perpendicular to an indicated “Y”axis.

As used herein, the singular forms “a,” “an,” and “the” are intended to include the plural forms as well, unless the context clearly indicates otherwise.

As used herein, the term “and/or” means and includes any and all combinations of one or more of the associated listed items.

As used herein, the term “pre-preg” means and includes a fiber material, such as a fiber tow or fiber sheet that is pre-impregnated with resin or matrix.

As used herein, the term “processor,” means and includes any machine capable of performing the calculations, or computations, to perform the tasks of the disclosure, and to control the mechanical and electrical devices in the disclosure. A “processor” includes any machine that is capable of accepting a structured input and/or of processing the input in accordance with prescribed rules to produce an output, as will be understood by those of ordinary skill in the art.

Composite layup processes may be used to form high-strength, lightweight parts for complex structures, such as aircraft, automobiles, aircraft engines, turbines, etc. Composite layup processes involve laying up multiple layers or plies of composite material to achieve a desired final thickness and shape of an associated composite structure. Many composite structures have complex shapes, such as frustoconical shapes, bi-conical shapes; spheroid shapes, etc., and/or combinations thereof.

When applying a layer or ply of composite material, such as a sheet of composite material including fiber suspended in a matrix or resin (e.g., prepreg) over a complex shape, portions of the layer or ply of composite material may deform relative to other portions to accommodate larger diameters in some portions of the complex shape. While the sheets of composite material may be configured to accommodate some deformation, larger differences may result in material defects, such as fiber separation, wrinkles, bubbles, etc. The material defects may result in a reduction in strength of the associate composite structure. The material defects may be corrected manually during the lay-up process using processes, such as relief cuts or applying additional segments of material. However, these correction processes are labor intensive, time consuming, and expensive. Forming sheets of composite material that are configured to accommodate larger differences in complex shapes may reduce labor costs and may result in faster production of the associated composite structures.

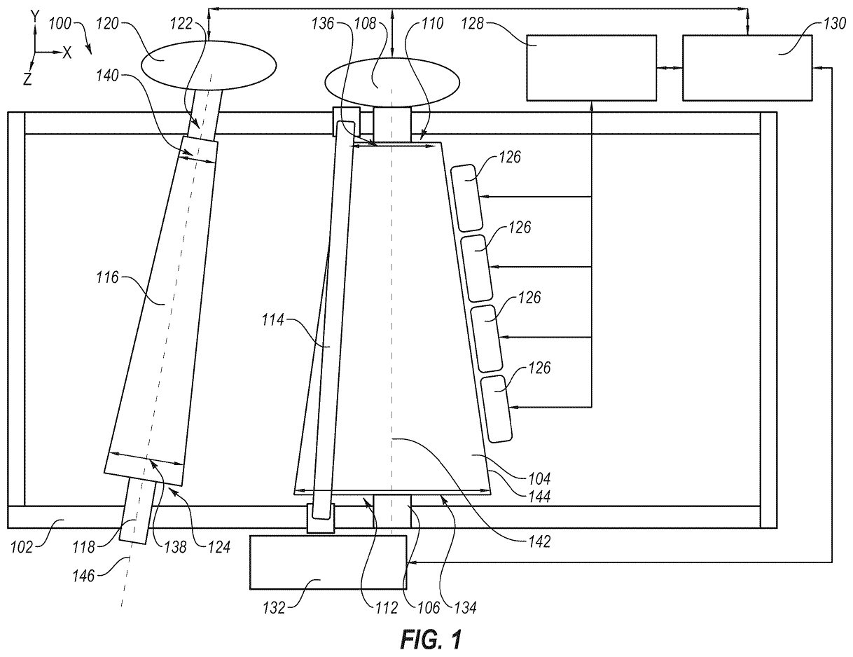

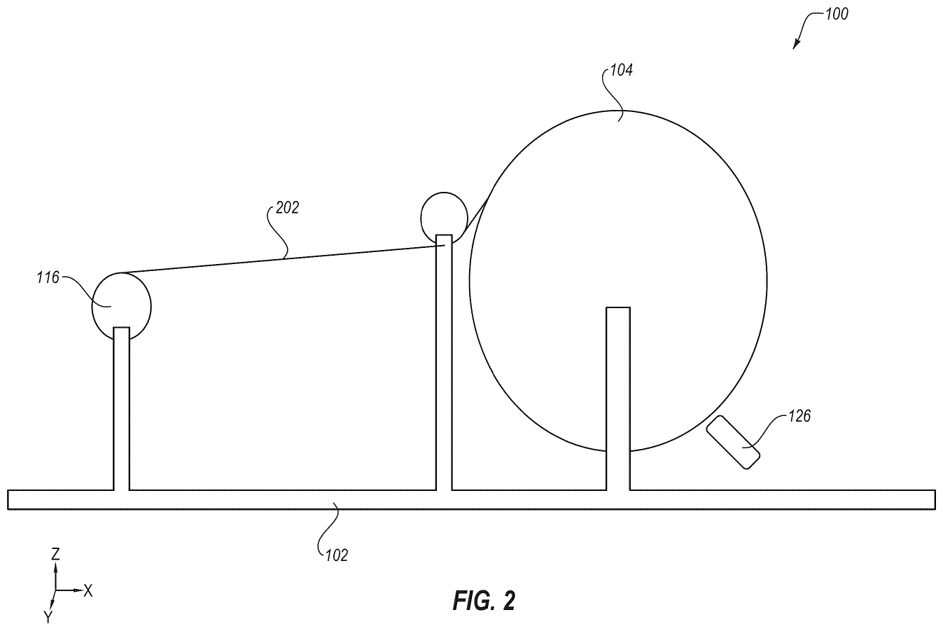

FIGS. 1 and 2 illustrate simplified schematic views of a forming system 100 configured to form a composite structure. The forming system 100 includes a frame 102 configured to support the elements of the forming system 100 and to maintain an arrangement (e.g., positions, spacing, relative angles, etc.) of the elements of the forming system 100. The forming system 100 includes a forming tool 104, such as a mandrel, form, or mold, which is rotatably secured to the frame 102 through a forming tool shaft 106.

The forming tool 104 may have a complex annular shape, such as a frustoconical shape, a bi-conical shape, a spheroid shape, tapered shape, etc. In the schematic drawings of FIGS. 1 and 2 the forming tool 104 is illustrated as a simplified frustoconical shape. However, the forming tool 104 may have a shape having several angular transitions or a radiused transition, such as a frustoconical shape having several angular transitions or a radiused transition from a small end 110 (e.g., relatively small end) to a large end 112 (e.g., relatively large end). For several of the processes described in the disclosure, a complex frustoconical shape may be simplified to a simple frustoconical shape, where a major dimension 136 (e.g., diameter, radius, width, apothem, etc.) of the small end 110 and a major dimension 134 of the large end 112 are substantially the same as a major dimension of the small end 110 of the complex frustoconical shape and a major dimension of the large end 112 of the complex frustoconical shape. The differences between the complex frustoconical shape and the resulting simple frustoconical shape may be accommodated by stretching the composite material being applied to the forming tool 104. The simplified frustoconical shape may be sized, such that the major dimension 136 of the small end 110 and the major dimension 134 of the large end 112 are slightly smaller than the major dimension of the small end 110 of the complex frustoconical shape and the major dimension of the large end 112 of the complex frustoconical shape, such that all portions of the composite material being applied to the forming tool 104 are in tension (e.g., there are no portions of the composite material in compression) during the application process.

A redirect 114 is coupled to the frame 102 adjacent the forming tool 104. The redirect 114 may optionally be configured to apply a tension to the composite material that may cause the composite material to stretch over the surface of the forming tool 104. In the embodiment illustrated in FIGS. 1 and 2, the redirect 114 extends at an angle relative to an axis 142 of the forming tool 104. In some embodiments, the angle of the redirect 114 is arranged to be equal to or less than an angle of the forming surface 144 of the forming tool 104 relative to the axis 142. For example, in the embodiment illustrated in FIG. 1, the angle of the redirect 114 relative to the axis 142 of the forming tool 104 is less than the angle of the forming surface 144 of the forming tool 104 relative to the axis 142 of the forming tool 104. The angle of the redirect 114 relative to the axis 142 of the forming tool 104 may be adjustable. For example, the redirect 114 may be slidably coupled to the frame 102, such that the position of each end of the redirect 114 may be independently adjustable for different configurations. The angle of the redirect 114 may apply greater tension to different regions of the forming tool 104. Thus, the angle of the redirect 114 may be set to apply a greater tension over areas of a complex frustoconical shape that have a major dimension greater than the associated major dimension of the simplified frustoconical shape to stretch the composite material in the associated regions.

The forming system 100 also includes a storage roller 116 rotatably coupled to the frame 102 through a storage roller shaft 118. The storage roller 116 may be loaded with a sheet 202 of the composite material. The storage roller 116 may optionally be configured to apply a tension to the composite material that may cause the composite material to stretch over the surface of the forming tool 104. The sheet 202 of the composite material may be fed onto the forming tool 104 from the storage roller 116 through the redirect 114, as illustrated in FIG. 2. The storage roller 116 has a shape that is similar to the simplified shape of the forming tool 104. For example, in the embodiment illustrated in FIG. 1, the storage roller 116 has a simplified frustoconical shape similar to the simplified frustoconical shape of the forming tool 104.

A size increase ratio of the storage roller 116 defined as a ratio of a major dimension 140 of the small end 122 of the storage roller 116 to a major dimension 138 of the large end 124 of the storage roller 116 may be substantially the same as a size increase ratio of the forming tool 104 defined as the ratio of the major dimension 136 of the small end 110 of the forming tool 104 to the major dimension 134 of the large end 112 of the forming tool 104. The increase ratios of each of the forming tool 104 and the storage roller 116 may be greater than a about 5% increase, such as greater than about 10%, or greater than about 30% increase.

The forming system 100 also includes one or more compactors 126 arranged along the forming surface 144 of the forming tool 104. The compactors 126 may include one or more of a roller, a pad, a squeegee, etc. The compactors 126 may be configured to apply a pressure in a direction normal to (e.g., perpendicular to) the forming surface 144. The pressure applied by the compactors 126 may facilitate adhesion between the sheet 202 of composite material and the forming surface 144 of the forming tool 104 or between subsequent plies or layers of the composite material.

The forming system 100 may include a compactor controller 128 configured to control aspects of the compactors 126, such as bringing the compactors 126 into contact with the forming surface 144 of the forming tool 104 or removing the compactors 126 from the forming surface 144 of the forming tool 104. In some embodiments, the compactor controller 128 controls a pressure applied to the forming surface 144 of the forming tool 104 by the compactors 126. In some embodiments, the compactor controller 128 controls heating or cooling of the compactors 126. For example, the compactors 126 may be heated to apply a heat to the composite material being applied to the forming tool 104, which may facilitate improved adhesion. In other embodiments, the compactors 126 may be cooled to facilitate applying pressure to the composite material on the forming surface 144 of the forming tool 104 while heat is applied to the composite material during a curing process.

The forming system 100 may also include a controller 130 configured to control the motion of one or more of the forming tool 104, the redirect 114, and the storage roller 116. The controller 130 may control a rotation speed of at least one of the forming tool 104 and the storage roller 116. For example, a forming tool motor 108 may be operatively coupled to the forming tool shaft 106, such that the forming tool motor 108 may rotate the forming tool 104 at a specified speed or torque. The rotation, rotational direction, torque, and rotational speed of the forming tool 104 may be controlled by the forming tool motor 108 through the controller 130. Similarly, a storage roller motor 120 may be operatively coupled to the storage roller 116, such that the storage roller motor 120 may rotate the storage roller 116 at a specified speed or torque. The rotation, rotational direction, torque, and rotational speed of the storage roller 116 may be controlled by the storage roller motor 120 through the controller 130.

In some embodiments, the controller 130 controls a position of one or more of the forming tool 104, redirect 114, and storage roller 116. For example, the controller 130 may control an angle between an axis 146 of the storage roller 116 relative to the axis 142 of the forming tool 104 and/or an angle of the redirect 114 relative to one or more of the axis 142 of the forming tool 104 and the axis 146 of the storage roller 116. The angle between the axis 146 of the storage roller relative to the axis 142 of the forming tool may be in a range from about 0° to about 45°, such as from about 0° to about 30°. The controller 130 may also control a vertical position (e.g., in the Z-direction) of the storage roller 116 and/or the redirect 114 relative to the forming tool 104.

The forming system 100 may also include a system controller 132. The system controller 132 may be configured to control the operation of the entire system, such as by providing instructions to the controller 130 and the compactor controller 128 and receiving data and measurements from the controller 130, the compactor controller 128, and/or directly from other sensors in the system. In some embodiments, the system controller 132 is an operator interface configured to display information and receive commands from an operator.

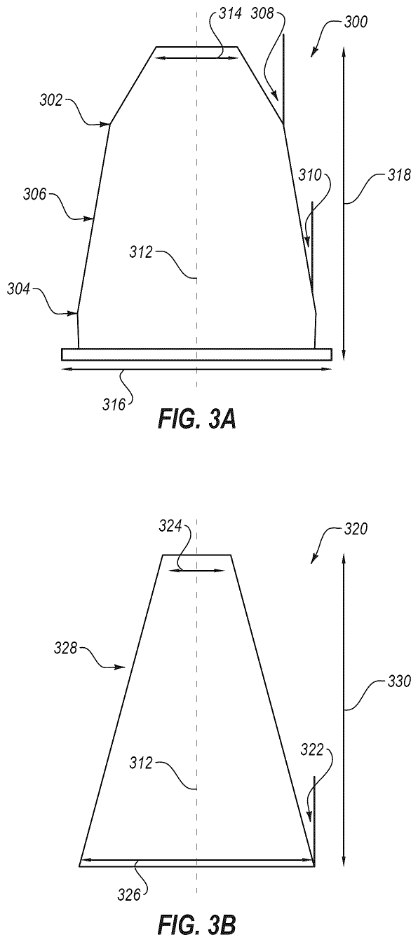

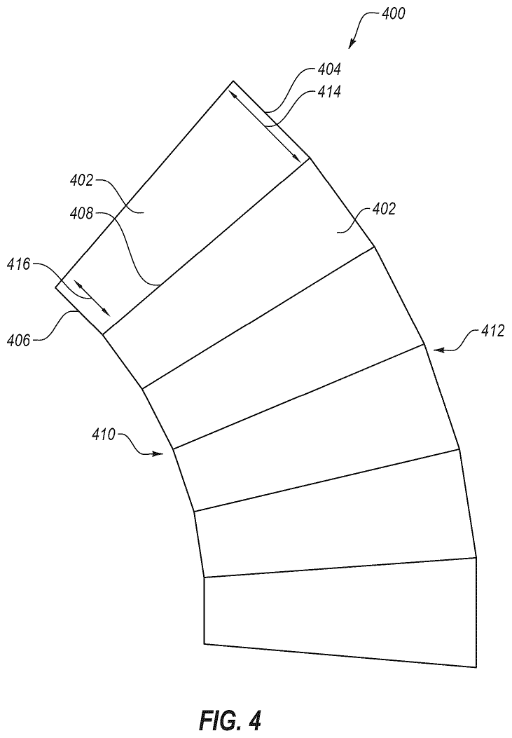

FIG. 3A illustrates an embodiment of a forming tool 300, such as the forming tool 104 used in the forming system 100. The forming tool 300 has a complex frustoconical shape including multiple transitions 302, 304 in the forming surface 306 between the two ends of the forming tool 300. At the first transition 302, the forming surface 306 transitions from a first angle 308 relative to an axis 312 of the forming tool 300 to a second angle 310 relative to the axis 312 of the forming tool 300. The forming tool 300 transitions from a small major dimension 314 to a large major dimension 316 across a length 318 of the forming tool 300 through the transitions 302, 304.

As discussed above, the complex frustoconical shape of the forming tool 300 may be modeled as a simplified frustoconical shape. FIG. 3B illustrates a model forming tool 320 configured to model the forming tool 300. The model forming tool 320 transitions from a small major dimension 324 to a large major dimension 326 across the length of the model forming tool 320, where the small major dimension 324 is the same as the small major dimension 314 of the forming tool 300 and the large major dimension 326 is the same as the large major dimension 316 of the forming tool 300. The length 330 of the model forming tool 320 is also the same as the length 318 of the forming tool 300. However, the surface 328 of the model forming tool 320 extends at the same angle 322 along the entire length of the model forming tool 320.

As noted above, covering forming tools having complex shapes, such as the forming tools 104 and 300, with conventional sheets of composite material may result in material defect, such as fiber separation, wrinkles, bubbles, etc. For examples, forming tools having increase ratios of greater than about 10%, such as greater than about 20% or greater than about 30%, may result in material defects in a conventional sheet of composite material when stretching the conventional sheet of composite material over the associated forming tool.

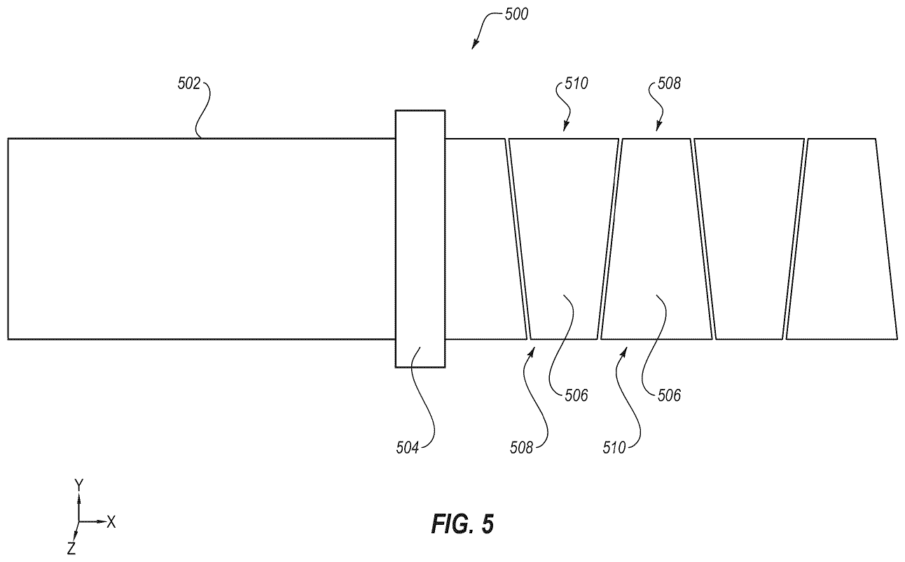

FIG. 4 illustrates a sheet of composite material 400 formed from multiple segments 402 of composite material. The sheet of composite material 400 illustrated in FIG. 4 is configured for covering a forming tool (e.g., forming tool 104 or forming tool 300) having a substantially frustoconical shape. As discussed above, the frustoconical shape may be a simplified frustoconical shape (e.g., forming tool 104) or a complex frustoconical shape (e.g., forming tool 300). The segments 402 of the sheet of composite material 400 may be non-rectangular shapes and non-parallelogram shapes. For example, the segments 402 may have triangular shapes, trapezoidal shapes, or irregular shapes. The segments 402 of the sheet of composite material 400 illustrated in FIG. 4 are trapezoidal shapes having a large (e.g., relatively large) end 404 and a small (e.g., relatively small) end 406. As illustrated in FIG. 4, the large end 404 of each segment 402 has a width 414 that is relatively greater than a width 416 of the small end 406. The ratio of the width 416 of the small end 406 to the width 414 of the large end 404 may be substantially the same as the increase ratio of the associated forming tool (e.g., forming tool 104, 300) and/or the associated storage roller (e.g., storage roller 116). The segments 402 are substantially uniform in dimensions, such that each segment 402 has substantially a same width 414 at the associated large ends 404 and each segment 402 has substantially a same width 416 at the associated small ends 406.

Each of the segments 402 are arranged adjacent to one another at a joint 408. Each of the segments 402 are arranged in a same direction, such that the large ends 404 are adjacent to one another and the small ends 406 are adjacent to one another. This arrangement of the segments 402 may result in an inner border 410 and an outer border 412 that are substantially curved.

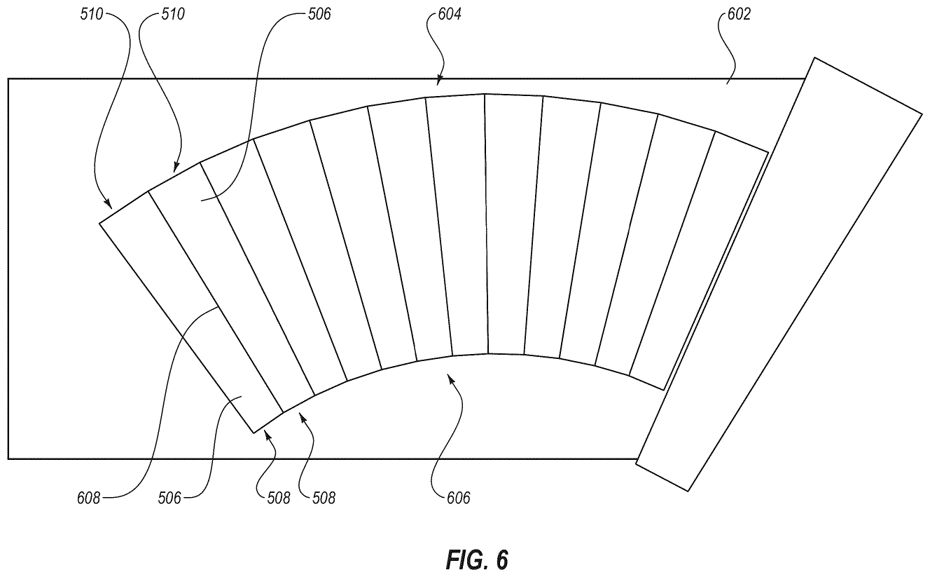

FIGS. 5-8 illustrate process acts of forming a sheet of composite material, such as the sheet of composite material 400. FIG. 5 illustrates a cutting apparatus 500 configured to cut patterns out of a base material 502. The base material 502 may be a composite base material, such as unidirectional dry fiber sheet, bidirectional dry fiber sheet, woven dry fiber sheet, uni-ply dry fiber sheet, multi-ply dry fiber sheet, unidirectional pre-preg sheet, bidirectional pre-preg sheet, woven prepreg sheet, uni-ply pre-preg sheet, multi-ply pre-preg sheet, etc.

As illustrated in FIG. 5, the base material 502 is cut into individual segments 506 by a cutter 504. The cutter 504 may include a mechanical cutter (e.g., a blade, a scribe cutter, a rolling cutter, a saw, etc.), a pulsed energy cutter (e.g., a laser cutter, a water jet cutter, etc.), etc. In some embodiments, the cutter 504 is computer controlled, such that a pattern may be designed and programmed into the computer and the computer may then control the cutter 504 to cut the pattern from the base material 502.

The pattern may be selected based on the fiber direction in the base material 502. For example, the pattern may be selected to reduce (e.g., minimize) a number of fibers that are cut or damaged in each segment 506 when forming the pattern. Reducing the number of fibers that are cut or damaged may increase a tensile strength of the associated segment 506 and result in greater stiffness and/or strength of the resulting composite structure. To minimize the number of cut or damaged fibers in each segment 506, the pattern may be selected such that the segments 506 are substantially aligned with the fiber direction of the base material 502. For example, in the embodiment illustrated in FIG. 5, if the fiber direction is a 90° fiber direction, such that the fibers extend in the Y-direction (substantially transverse to the longitudinal dimension (e.g., in the X-direction)) of the base material 502, the fibers in the base material 502 may extend from a small (e.g., relatively small) end 508 of each segment 506 to a large (e.g., relatively large) end 510 of each segment. Thus, a larger percentage of the fibers may extend the full length of each segment 506 without being cut or damaged.

In the embodiment illustrated in FIG. 5, the cutter 504 is configured to cut trapezoidal segments 506 in a 90° orientation, such that the trapezoidal segments 506 extend across the base material 502 from the small end 508 to the large end 510 in a direction transverse to (e.g., perpendicular to or at 90° relative to) a travel direction (e.g., longitudinal direction or X-direction) of the base material 502 (e.g., where the trapezoidal segments 506 extend in the Y-direction). As illustrated in FIG. 5, the trapezoidal segments 506 may be cut in alternating directions, such that the small end 508 of a first segment 506 is adjacent to the large end 510 of a second segment 506 and similarly, such that the large end 510 of the first segment 506 is adjacent to the small end 508 of the second segment 506. In other words, the small end 508 of the first segment 506 is staggered with the large end 510 of the second segment 506 along the base material 502. This arrangement may increase a yield from the base material 502 by reducing waste or scrap material produced by the cutting process.

After cutting the segments 506 from the base material 502, the segments 506 are arranged on a backing material 602. The backing material 602 may be made from any suitable material such as, but not limited to, polymer materials (e.g., polyethylene, polyurethane, etc.), paper materials, etc. The backing material 602 may be treated for controlled adhesion on a side of the backing material 602 where the segments 506 are arranged, such that the segments 506 adhere to the surface of the backing material 602. For example, the backing material 602 may be treated by a surface treatment device, such as a corona discharge device, configured to treat the backing material 602 to control adhesion properties, such as by generating an electrical discharge. In other embodiments, the backing material 602 may include an adhesive configured to removably secure the segments 506 to the backing material 602.

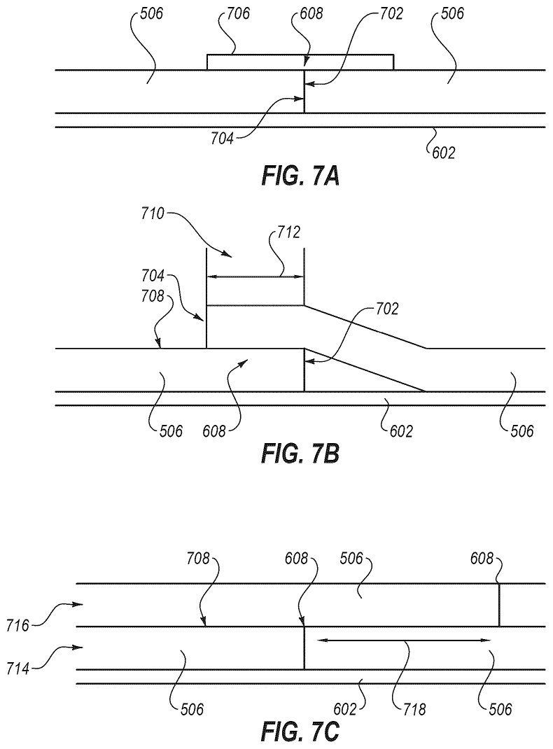

The segments 506 are arranged adjacent to one another with the small ends 508 adjacent to one another and the large ends 510 adjacent to one another, such that the large ends 510 of each of the segments 506 combine to form an outer edge 604 and the small ends 508 of each of the segments 506 combine to form an inner edge 606. The arrangement of segments 506 results in the outer edge 604 and the inner edge 606 having a substantially curved shape as illustrated in FIG. 6.

In some embodiments, the segments 506 are joined together along a joint 608 between the segments 506 with an adhesive, such as a tape configured to secure the segments 506 relative to one another throughout the layup process until the curing process. In other embodiments, the adhesion to the backing material 602 is relied upon to maintain the positional arrangement between the segments 506 until the backing material 602 is removed and adhesion between the segments 506 and another composite ply or the forming tool continues to maintain the arrangement.

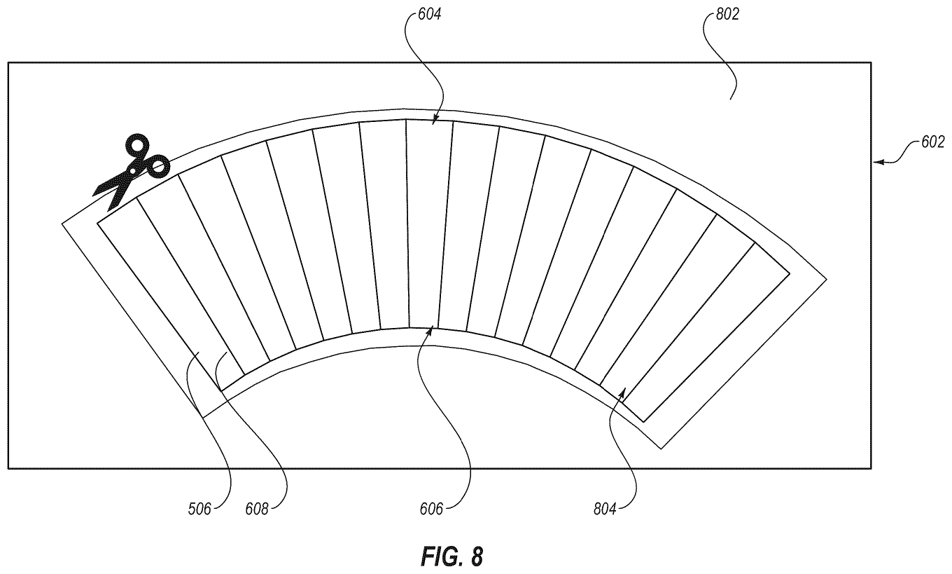

FIGS. 7A-7C illustrate different embodiments for the joint 608 between adjacent segments 506. In FIGS. 7A-7C, the dimensions are exaggerated for illustrative purposes. In some embodiments, the joint 608 is a butt joint with no overlap between the adjoining segments 506 as illustrated in FIG. 7A. In other embodiments, the joint 608 is a partially overlapped joint where a fraction of the adjoining segments 506 overlap each other at the joint 608 as illustrated in FIG. 7B. In other embodiments, two plies are applied together with offset butt joints such that each joint is fully encompassed by an overlapping segment 506 as illustrated in FIG. 7C.

FIG. 7A illustrates a butt joint between two segments 506. At the joint 608 between the two segments 506, a first lateral edge 702 of a first segment 506 abuts a second lateral edge 704 of a second segment 506 with substantially no gap defined between the first lateral edge 702 and the second lateral edge 704. As discussed above, the first segment 506 and the second segment 506 may be joined together by an adhesive material 706, such as tape spanning the joint 608 between the two segments 506. In other embodiments, the adhesive material 706 may be placed on the backing material 602 to reinforce the joint.

FIG. 7B illustrates an overlapping joint between two segments 506. In the embodiment illustrated in FIG. 7B, the second lateral edge 704 extends past the first lateral edge 702, such that the second segment 506 extends over a portion of an upper surface 708 of the first segment 506. An overlap region 710 is defined between the first lateral edge 702 and the second lateral edge 704. The overlap region 710 may form the joint 608 between the first segment 506 and the second segment 506.

A width 712 of the overlap region 710 may be defined as a percentage of a total width of the segments 506, For example, a 50% overlap width 712 may position the second lateral edge 704 proximate a center of the upper surface 708 of the first segment 506 whereas a 10% overlap width 712 may position the second lateral edge 704 closer to the first lateral edge 702 than to the center of the upper surface 708 of the segment 506. A 50% overlap width 712 may cause the resulting sheet of composite material to have about two plies (e.g., two layers) of composite material due to each segment 506 overlapping half of the proceeding segment 506. The width 712 of the overlap region 710 may be in a range from about 0% (e.g., the butt joint illustrated in FIG. 7A) to about 50%, such as in a range from about 10% to about 50% or from about 10% to about 30%. In some embodiments, the width 712 of the overlap region 710 is defined as a distance independent of the total width of the segments 506. For example, the width 712 of the overlap region 710 may be in a range from about 0 inches (0 cm) to about 5 inches (127 cm), such as from about 1 inch (25.4 cm) to about 3 inches (76.2 cm).

In some embodiments, the first segment 506 and the second segment 506 may adhere to one another in the overlap region 710. In other embodiments, an adhesive material, such as the adhesive material 706, may be positioned between the first segment 506 and the second segment 506 in the overlap region 710, securing the first segment 506 to the second segment 506 in the overlap region 710.

FIG. 7C illustrates a multi-ply sheet of material with overlapping joints 608. In the embodiment illustrated in FIG. 7C, a first ply 714 including multiple segments 506 is applied over the backing material 602. The first ply 714 is formed from the segments 506 abutted against each other at the joint 608, similar to the butt joint illustrated in FIG. 7A. A second ply 716 including multiple segments 506 is applied over the first ply 714. The second ply 716 is also formed from the segments 506 abutted against each other at the joints 608, similar to the butt joint illustrated in FIG. 7A.

The joints 608 in the second ply 716 are offset from the joints 608 in the first ply 714, such that the joints 608 in the second ply 716 do not align with the joints 608 in the first ply 714. An offset distance 718 between the joint 608 of the second ply 716 and the joint 608 of the first ply 714 may be defined as a percentage of a total width of the segments 506, For example, a 50% offset distance 718 may position the joint 608 of the second ply 716 proximate a center of the upper surface 708 between the joints 608 of the first ply 714 where a 10% offset distance 718 may position the joint 608 of the second ply 716 closer to the joint 608 of the first ply 714 than to the center of the upper surface 708 between the joints 608 of the first ply 714. The offset distance 718 between the first ply 714 and the second ply 716 may be in a range from about 10% to about 50% or from about 30% to about 50%.

In some embodiments, the segments 506 in the second ply 716 may adhere to segments 506 in the first ply 714, securing the segments 506 in the first ply 714. In other embodiments, an adhesive material, such as the adhesive material 706, may be positioned between the first ply 714 and the second ply 716, securing the segments 506 to each other across the associated joints 608 and/or securing the first ply 714 to the second ply 716.

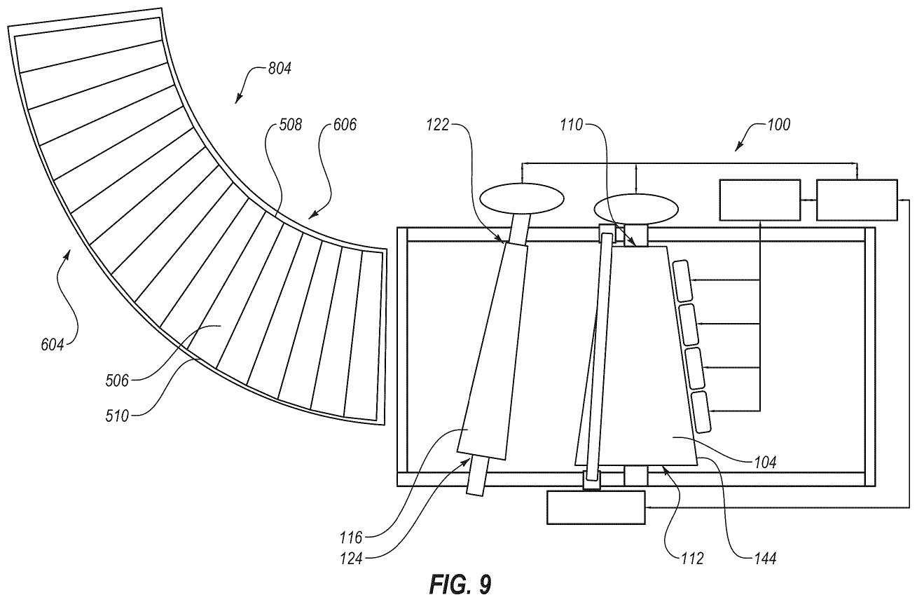

After the individual segments 506 are arranged on the backing material 602, excess backing material 802 (FIG. 8) may be removed to form a sheet of composite material 804. The excess backing material 802 may be removed through a cutting process. In some embodiments, the excess backing material 802 is removed in a manual trimming process. In other embodiments, the excess backing material 802 is removed through an automated process, such as by a cutting apparatus, similar to the cutting apparatus 500 (FIG. 5) used to create the segments 506 from the base material 502 (FIG. 5).

The backing material 602 may be trimmed to substantially match the curved shape of the segments 506. For example, the trimmed sheet of composite material 804 may substantially match the curved outer edge 604 and the curved inner edge 606 of the arrangement of segments 506.

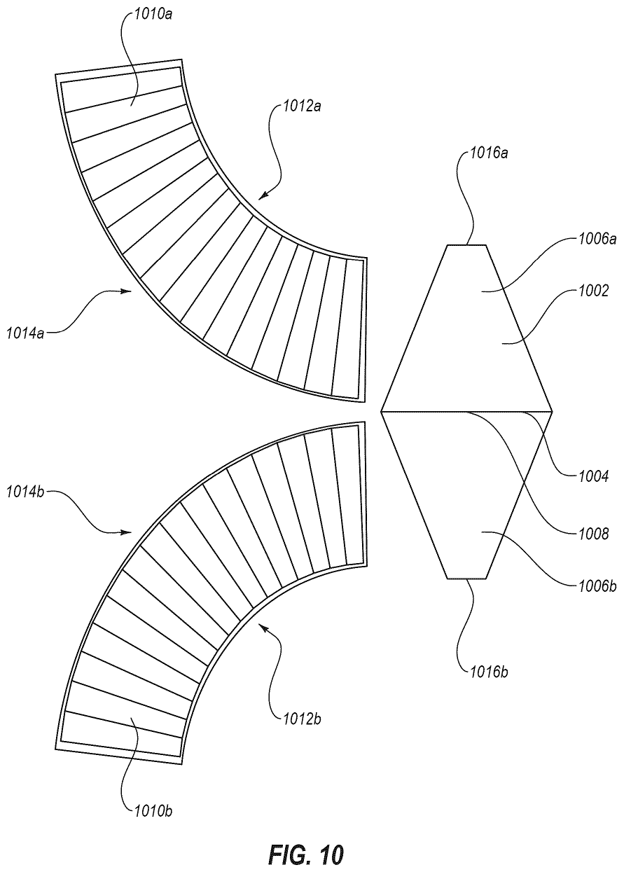

After the excess backing material 802 is removed to form the sheet of composite material 804, the sheet of composite material 804 is loaded into at least a portion of a forming system, such as the forming system 100. FIG. 9 illustrates the sheet of composite material 804 being loaded into the forming system 100. The sheet of composite material 804 may be loaded onto the storage roller 116. In some embodiments, the sheet of composite material 804 is loaded onto the storage roller 116 directly on the forming system 100 as illustrated in FIG. 9. In other embodiments, the sheet of composite material 804 may be loaded onto the storage roller 116 in a separate act, such as using a separate apparatus to load the storage roller 116. The loaded storage roller 116 may then be inserted into the forming system 100 with the sheet of composite material 804 already loaded onto the storage roller 116. For example, multiple storage rollers 116 may be loaded with the associated sheets of composite material 804 and then stored, such that a part may be formed on the forming tool 104 by changing out the storage roller 116 for each ply without reloading the storage roller 116 for each ply.

The sheet of composite material 804 is loaded onto the storage roller 116 with the inner edge 606, which corresponds to the small ends 508 of the individual segments 506, aligning with the small end 122 of the storage roller 116 and with the outer edge 604, which corresponds to the large ends 510 of the individual segments 506, aligning with the large end 124 of the storage roller 116. As discussed above, the ratio between the major dimension of the small end 508 of each segment 506 and the major dimension of the large end 510 of each segment 506 is the same as the ratio between the major dimension of the small end 122 of the storage roller 116 and the major dimension of the large end 124 of the storage roller 116. Similarly, a ratio between the length of the inner edge 606 and the length of the joint 608 of the sheet of composite material 804 is the same as the ratio between the major dimension of the small end 122 of the storage roller 116 and the major dimension of the large end 124 of the storage roller 116 and the ratio between the major dimension of the small end 508 of each segment 506 and the major dimension of the large end 510 of each segment 506.

The sheet of composite material 804 may be sized and configured to completely encompass the forming surface 144 of the forming tool 104 one-time (e.g., a single time), such that the sheet of composite material 804 forms one ply of the resulting composite structure. The storage roller 116 may have smaller major dimensions at the small end 122 and the large end 124 than the small end 110 and the large end 112 of the forming tool 104, while having a length that is substantially the same, such that the storage roller 116 takes up less space in the forming system 100. The smaller dimensions of the storage roller 116 may result in the sheet of composite material 804 encompassing the storage roller 116 multiple times. Matching the ratios between the small ends 110, 122, 508 and the large ends 112, 124, 510 may facilitate rolling the sheet of composite material 804 evenly onto both the storage roller 116 and the forming tool 104 regardless of the size differences between the storage roller 116 and the forming tool 104.

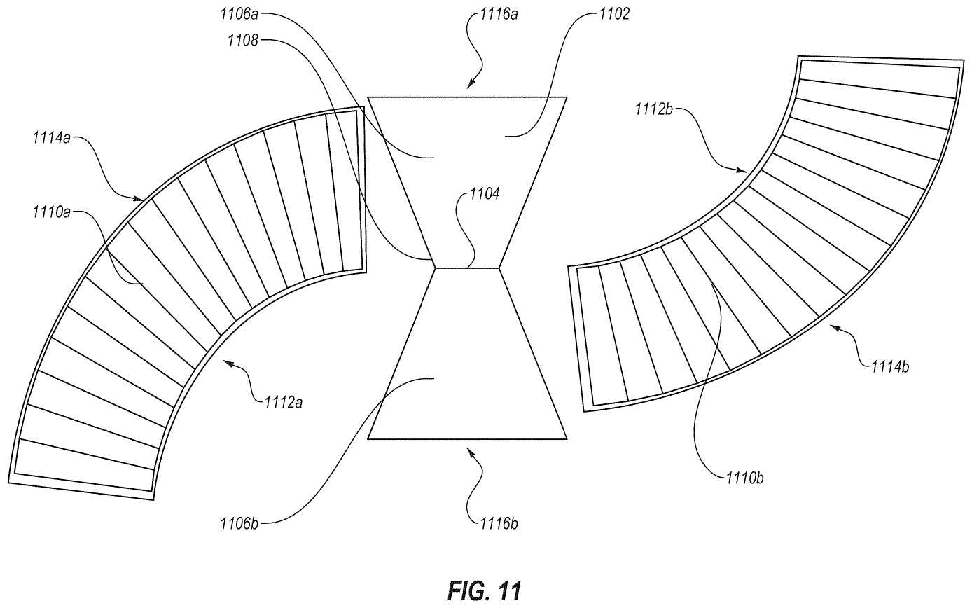

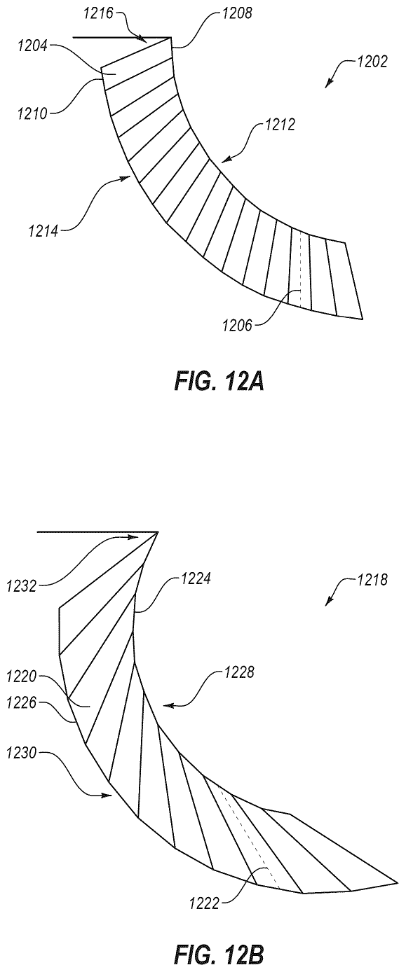

FIGS. 10 and 11 illustrate embodiments of forming tools and sheets of composite materials for forming composite structures having other complex shapes. FIG. 10 illustrates a forming tool having a substantially bi-conical shape and FIG. 11 illustrates a forming tool having a double-conical shape. As discussed above, the simplified shapes illustrated in FIGS. 10 and 11 may be used to model more complex shapes, such as spheroids and nozzles.

FIG. 10 illustrates a forming tool 1002 that includes a transition 1004 from a first frustoconical shape 1006a to a second frustoconical shape 1006b. The transition 1004 is at the large ends 1008 of each of the first frustoconical shape 1006a and the second frustoconical shape 1006b, such that a major dimension of the forming tool 1002 decreases as the forming tool 1002 extends away from the transition 1004. Two separate sheets of composite material 1010a, 1010b may be applied. The sheets of composite material 1010a, 1010b may be arranged such that the outer edges 1014a, 1014b align with the transition 1004 at the large ends 1008 of the frustoconical shapes 1006a, 1006b and the inner edges 1012a, 1012b are proximate the small ends 1016a, 1016b of the frustoconical shapes 1006a, 1006b. Thus, the sheets of composite material 1010a, 1010b are arranged such that the outer edges 1014a, 1014b of the sheets of composite material 1010a, 1010b are proximal to one another and the inner edges 1012a, 1012b of the sheets of composite material 1010a, 1010b are distal to one another. In some embodiments, outer edges 1014a, 1014b are seamed together and wrapped on the storage roller 116 as a single sheet.

In the embodiment illustrated in FIG. 10, the first frustoconical shape 1006a and the second frustoconical shape 1006b are illustrated as having substantially a same shape. Therefore, the first frustoconical shape 1006a and the second frustoconical shape 1006b may have substantially a same ratio between the large ends 1008 and the small ends 1016a, 1016b. Similarly, the ratio between the outer edges 1014a, 1014b and the inner edges 1012a, 1012b of the sheets of composite material 1010a, 1010b may be substantially the same. In other embodiments, the first frustoconical shape 1006a and the second frustoconical shape 1006b may have different ratios between the large ends 1008 and the small ends 1016a, 1016b. As discussed above, the ratio between the outer edges 1014a, 1014b and the inner edges 1012a, 1012b of the sheets of composite material 1010a, 1010b may then be matched to the associated frustoconical shapes 1006a, 1006b. For example, the ratio between the outer edge 1014a and the inner edge 1012a of the first sheet of composite material 1010a will match the ratio between the large end 1008 and the small end 1016a of the first frustoconical shape 1006a and the ratio between the outer edge 1014b and the inner edge 1012b of the second sheet of composite material 1010b will match the ratio between the large end 1008 and the small end 1016b of the second frustoconical shape 1006b.

While not illustrated in FIG. 10, the sheets of composite material 1010a, 1010b may first be rolled onto a storage roller (e.g., storage roller 116) before being rolled onto the forming tool 1002. As discussed above, the storage roller may also have matching ratios between a large region at a transition and the small regions on the opposing ends of the storage roller to facilitate rolling the sheets of composite material 1010a, 1010b uniformly onto the storage roller and then transferring the sheets of composite material 1010a, 1010b from the storage roller to the forming tool 1002.

FIG. 11 illustrates a forming tool 1102 that includes a transition 1104 from a first frustoconical shape 1106a to a second frustoconical shape 1106b. The transition 1104 is at the small ends 1108 of each of the first frustoconical shape 1106a and the second frustoconical shape 1106b, such that a major dimension of the forming tool 1102 increases as the forming tool 1102 extends away from the transition 1104. Two separate sheets of composite material 1110a, 1110b may be applied. The sheets of composite material 1110a, 1110b may be arranged such that the inner edges 1112a, 1112b align with the transition 1104 at the small ends 1108 of the frustoconical shapes 1106a, 1106b and the outer edges 1014a, 1014b are proximate the large ends 1116a, 1116b of the frustoconical shapes 1106a, 1106b. Thus, the sheets of composite material 1110a, 1110b are arranged such that the inner edges 1112a, 1112b of the sheets of composite material 1110a, 1110b are proximal to one another and the outer edges 1114a, 1114b of the sheets of composite material 1110a, 1110b are distal to one another.

In the embodiment illustrated in FIG. 11, the first frustoconical shape 1106a and the second frustoconical shape 1106b are illustrated as having substantially a same shape. Therefore, the first frustoconical shape 1106a and the second frustoconical shape 1106b may have substantially a same ratio between the large ends 1116a, 1116b and the small ends 1108. Similarly, the ratio between the outer edges 1114a, 1114b and the inner edges 1112a, 1112b of the sheets of composite material 1110a, 1110b may be substantially the same. In other embodiments, the first frustoconical shape 1106a and the second frustoconical shape 1106b may have different ratios between the large ends 1116a, 1116b and the small ends 1108. As discussed above, the ratio between the outer edges 1114a, 1114b and the inner edges 1112a, 1112b of the sheets of composite material 1110a, 1110b may then be matched to the associated frustoconical shapes 1106a, 1106b. For example, the ratio between the outer edge 1114a and the inner edge 1112a of the first sheet of composite material 1110a may match the ratio between the large end 1116a and the small end 1108 of the first frustoconical shape 1106a and the ratio between the outer edge 1114b and the inner edge 1112b of the second sheet of composite material 1110b may match the ratio between the large end 1116b and the small end 1108 of the second frustoconical shape 1106b.

While not illustrated in FIG. 11, the sheets of composite material 1110a, 1110b may first be rolled onto a storage roller (e.g., storage roller 116) before being rolled onto the forming tool 1102. As discussed above, the storage roller will also have matching ratios between a large region at a transition and the small regions on the opposing ends of the storage roller to facilitate rolling the sheets of composite material 1110a, 1110b uniformly onto the storage roller and then transferring the sheets of composite material 1110a, 1110b from the storage roller to the forming tool 1102.

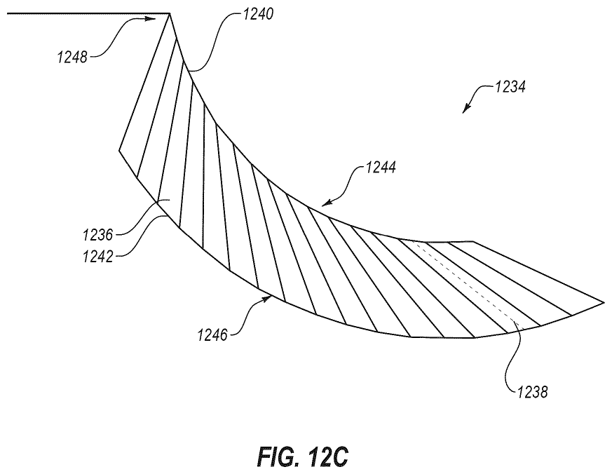

FIG. 12A-12C illustrate sheets of composite material 1202, 1218, 1234 configured to form a composite structure having complex geometry. The sheets of composite material 1202, 1218, 1234 are configured to achieve different fiber angle orientations on the composite structure while maintaining minimal fiber damage in each segment 1204, 1220, 1236. As used herein, fiber angles when directed to a composite structure formed over a forming tool is defined where a 0° fiber angle is substantially parallel with an axis of the forming tool and a 90° fiber angle is substantially transverse to the axis of the forming tool (e.g., in the hoop direction). For example, in the sheet of composite material 804 discussed above, minimal fiber damage is achieved by forming the individual segments 506, such that the segments 506 are substantially aligned with the fiber direction of the base material 502 (e.g., such that the fibers in the base material 502 extend from a small end 508 of each segment 506 to a large end 510 of each segment). The shape of the segments 506 and the fiber direction in the segments 506 of the sheet of composite material 804 may result in a fiber angle of 0° once the sheet of composite material 804 is applied to the associated forming tool. A composite structure may be formed from multiple plies of material having different fiber angles that provide structural support in different directions.

The segments 1204, 1220, 1236 of each of the sheets of composite material 1202, 1218, 1234 are sized and shaped to facilitate an angled arrangement. The angled arrangement of the segments 1204, 1220, 1236 may cause the segments 1204, 1220, 1236 to wrap helically around the associated forming tool at substantially a same angle as the desired fiber angle.

The segments 1204, 1220, 1236, of FIGS. 12A-12C may be formed as obtuse trapezoidal shapes where the angles of the corners of the segments 1204, 1220, 1236, define an offset angle 1216, 1232, 1248 of the segments 1204, 1220, 1236. For example, the sheet of composite material 1202 of FIG. 12A has an offset angle 1216 that is less than an offset angle 1232 of the sheet of composite material 1218 of FIG. 12B and the offset angle 1232 of the sheet of composite material 1218 of FIG. 12B is smaller than the offset angle 1248 of the sheet of composite material 1234 of FIG. 12C. The offset angle 1216, 1232, 1248 of the segments 1204, 1220, 1236, along with the orientation of the fibers 1206, 1222, 1238 in the segments 1204, 1220, 1236, may define the fiber angle of the sheets of composite material 1202, 1218, 1234 when applied to the forming tool. The angle of the fibers 1206, 1222, 1238 may alternatively be the wrap direction of a woven material or the down roll direction of a multi axial material.

Each of the segments 1204, 1220, 1236 include a small end 1208, 1224, 1240 and a large end 1210, 1226, 1242. As discussed above, the ratio between the small end 1208, 1224, 1240 and the large end 1210, 1226, 1242 is substantially the same as a ratio between the small end and the large end of the associated forming tool. Similarly, the arrangement of segments 1204, 1220, 1236 defines an inner edge 1212, 1228, 1244 and an outer edge 1214, 1230, 1246 which will have the same ratio between the inner edge 1212, 1228, 1244 and the outer edge 1214, 1230, 1246 as the ratios between the small end 1208, 1224, 1240 and the large end 1210, 1226, 1242 and between the small end and the large end of the associated forming tool.

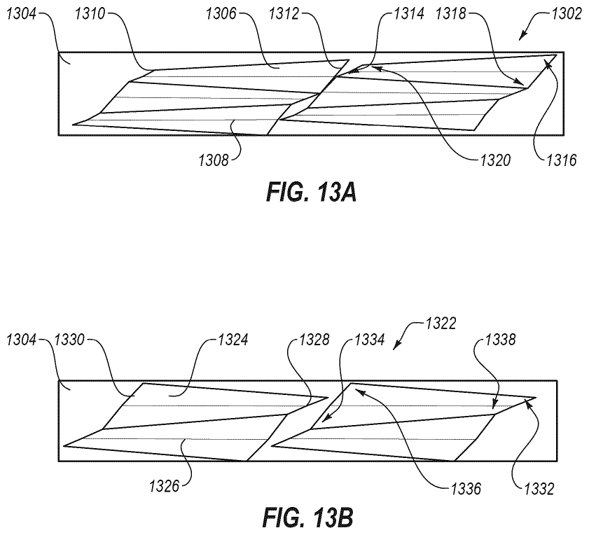

FIGS. 13A and 13B illustrate patterns 1302, 1322 for cutting segments 1306, 1324 from a base material 1304. The segments 1306, 1324 illustrated in FIGS. 13A and 13B may be configured to form the sheets of composite material 1202, 1218, 1234 discussed above, to facilitate an angled arrangement of the segments 1306, 1324.

As illustrated in FIGS. 13A and 13B, the fibers 1308, 1326 extend between a small end 1310, 1328 and a large end 1312, 1330 of each segment 1306, 1324. As discussed above, the segments 1306, 1324 may be oblique trapezoidal shapes, such that each of the angles 1314, 1316, 1318, 1320, 1332, 1334, 1336, 1338 of the associated segments 1306, 1324 are different.

In the embodiment illustrated in FIG. 13A, the segments 1306 each have a substantially uniform shape. The small ends 1310 of each of the segments 1306 may extend at a different angle than the large ends 1312 of each of the segments 1306 to facilitate the helical pattern discussed above. In the embodiment illustrated in FIG. 13A, the small ends 1310 extend at a smaller angle relative to the fiber 1308 than the large ends 1312.

The oblique trapezoidal shape of the segments 1306 may define four angles 1314, 1316, 1318, 1320. As noted above, each of the angles 1314, 1316, 1318, 1320 are different. In the embodiment illustrated in FIG. 13A, one angle 1314, 1316 at each of the small end 1310 and the large end 1312 of each segment 1306 is an acute angle (e.g., less than 90°), whereas the angle 1314 on the small end 1310 is less than the angle 1316 on the large end 1312. The second angle 1320 on the small end 1310 of each segment 1306 is an obtuse angle (e.g., greater than 90°). The second angle 1318 on the large end 1312 of each segment is also an obtuse angle and is less than the second angle 1320 on the small end 1310.

In the embodiment illustrated in FIG. 13B, the segments 1324 each also have a substantially uniform shape. The small ends 1328 of each of the segments 1324 may extend at a different angle than the large ends 1330 of each of the segments 1324 to facilitate the helical pattern discussed above. In the embodiment illustrated in FIG. 13B, the small ends 1328 extend at a smaller angle relative to the fiber 1326 than the large ends 1330. The difference between the angles of the small ends 1328 and the large ends 1330 of the segments 1324 illustrated in FIG. 13B may be greater than the difference between the angles of the small ends 1310 and the large ends 1312 of the segments 1306 illustrated in FIG. 13A. The different angles illustrated the segments 1324 of FIG. 13B, may facilitate forming a ply on the composite structure having a greater fiber angle than the segments 1306 of FIG. 13A.

The oblique trapezoidal shape of the segments 1324 may define four angles 1332, 1334, 1336, 1338. As noted above, each of the angles 1332, 1334, 1336, 1338, are different. In the embodiment illustrated in FIG. 13B, one angle 1332, 1334 at each of the small end 1328 and the large end 1330 of each segment 1324 is an acute angle, whereas the angle 1332 on the small end 1328 is less than the angle 1334 on the large end 1330. The angle 1332 on the small end 1328 of the segment 1324 is also smaller than the angle 1314 on the small end 1310 of the segment 1306 illustrated in FIG. 13A. The second angle 1338 on the small end 1328 of each segment 1324 is an obtuse angle. The second angle 1336 on the large end 1330 of each segment is also an obtuse angle and is less than the second angle 1338 on the small end 1328.

The oblique trapezoidal shape of the segments 1306, 1324 of FIGS. 13A and 13B may result in the respective fibers 1308, 1326 being slightly angularly offset from the respective segment 1306, 1324. For example, the fibers 1308, 1326 may be angularly offset from the segments 1306, 1324 by an angle in a range from about 1° to about 10°, such as in a range from about 2° to about 7°, or from about 3° to about 5°. The offset of the fibers 1308, 1326 may be configured to maintain an angle closer to the desired fiber angle throughout the respective segment 1306, 1324. For example, the angle of the respective fibers 1308, 1326 may change across the segments 1306, 1324. As illustrated in FIGS. 13A and 13B, the angle of incidence of the fibers 1308, 1326 at the small end 1310, 1328 is different from the angle of incidence of the fibers 1308, 1326 at the large end 1312, 1330. Angularly offsetting the fibers 1308, 1326 may cause the fiber angle to be more uniform across the segment 1306, 1324 and the average fiber angle to be closer to the desired fiber angle.

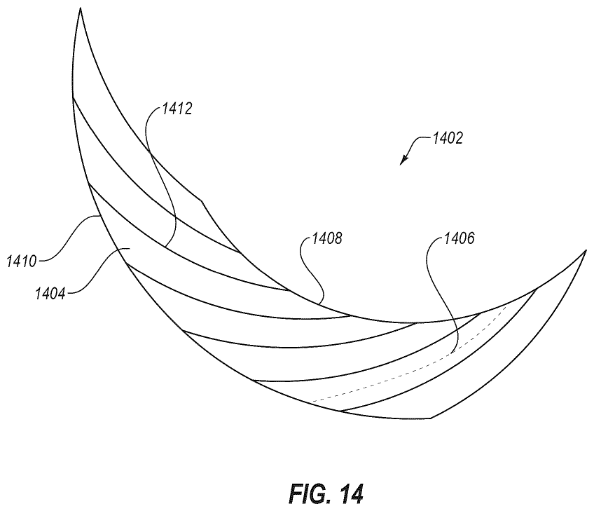

FIG. 14 illustrates another embodiment of a sheet of composite material 1402 formed from segments 1404. The segments 1404 of the sheet of composite material 1402 are formed as radiused trapezoids. Each segment 1404 has a small end 1408 and a large end 1410. As discussed above, the ratio between the size of the small end 1408 and the large end 1410 is substantially the same as the ratio between a major dimension of the small end and a major dimension of the large end of the associated forming tool.

The segments 1404 of the sheet of composite material 1402 include sides 1412 that extend between the small end 1408 and the large end 1410. The sides 1412 are curved at a radius substantially matching a radius of the designed path of the segments 1404. As discussed above, the segments 1404 may be designed to follow a helical path around the forming tool. Thus, the sides 1412 may be curved to substantially match the helical path of the segments 1404. In some embodiments, the base material used to form the segments 1404 may be steered, such that the fibers 1406 in the segments 1404 follow a similar curvature to the sides 1412. This may facilitate the fibers 1406 maintaining a constant fiber angle throughout the segment 1404, by following an involute path or other curve. Thus, an angle of incidence of a fiber 1406 with at the small end 1408 may be substantially the same as an angle of incidence of the fiber 1406 with large end 1410.

Embodiments of the disclosure may facilitate forming sheets of material that may be directly laid up on a forming tool having a large increase ratio between a small end and a large end. Sheets of material that can be directly laid up on a forming tool may facilitate automating the lay-up process, which saves time and labor when forming an associated composite structure.

Embodiments of the disclosure may also facilitate minimizing fiber and matrix damage when laying up a composite structure having a large increase ratio between a small end and a large end. Minimizing fiber and matrix damage during lay-up, results in composite structures having greater strength and improved reliability. This may also result in fewer anomalies in the layup, such as wrinkles, bubbles, fiber separation, etc., that may result in a failed composite structure (e.g., a structure that fails during inspection or a structure that catastrophically fails during use).

The embodiments of the disclosure described above and illustrated in the accompanying drawing figures do not limit the scope of the invention, since these embodiments are merely examples of embodiments of the invention, which is defined by the appended claims and their legal equivalents. Any equivalent embodiments are intended to be within the scope of this disclosure. Indeed, various modifications of the present disclosure, in addition to those shown and described herein, such as alternative useful combinations of the elements described, may become apparent to those skilled in the art from the description. Such modifications and embodiments are also intended to fall within the scope of the appended claims and their legal equivalents.

What is claimed is:

1. A sheet of composite material comprising:
at least two non-rectangular segments of composite material, a first non-rectangular segment of the at least two non-rectangular segments positioned adjacent to a second non-rectangular segment of the at least two non-rectangular segments, the first non-rectangular segment coupled to the second non-rectangular segment along lateral edges of the first non-rectangular segment and the second non-rectangular segment.

2. The sheet of claim 1, wherein a first inner edge of the first non-rectangular segment forms an acute angle relative to a second inner edge of the second non-rectangular segment.

3. The sheet of claim 1, wherein the first non-rectangular segment and the second non-rectangular segment are substantially a same size and a same shape.

4. The sheet of claim 1, wherein the first non-rectangular segment includes a first small end and a first large end and the second non-rectangular segment includes a second small end and a second large end.

5. The sheet of claim 4, wherein the first small end of the first non-rectangular segment is positioned adjacent the second small end of the second non-rectangular segment and wherein the first large end of the first non-rectangular segment is positioned adjacent the second large end of the second non-rectangular segment.

6. The sheet of claim 4, wherein the first small end of the first non-rectangular segment defines an acute angle between the first small end of the first non-rectangular segment and a first side of the first non-rectangular segment and the first small end of the first non-rectangular segment defines an oblique angle between the first small end of the first non-rectangular segment and a second side of the first non-rectangular segment.

7. The sheet of claim 4, wherein the first large end of the first non-rectangular segment defines an acute angle between the first large end of the first non-rectangular segment and a first side of the first non-rectangular segment and the first large end of the first non-rectangular segment defines an oblique angle between the first large end of the first non-rectangular segment and a second side of the first non-rectangular segment.

8. The sheet of claim 4, wherein the first non-rectangular segment further includes two curved sides extending from the first small end to the first large end.

9. The sheet of claim 4, wherein one or more fibers of the first non-rectangular segment extend from the first small end of the first non-rectangular segment to the first large end of the first non-rectangular segment.

10. The sheet of claim 1, further comprising a backing material, wherein the at least two non-rectangular segments of the composite material are applied to the backing material.

11. A method of forming a composite structure, the method comprising:
positioning non-rectangular segments of a composite material on a backing material in a curved arrangement;
applying the composite material to a mandrel; and
removing the backing material.

12. The method of claim 11, further comprising cutting the non-rectangular segments from a base material.

13. The method of claim 12, wherein the mandrel is a substantially frustoconically-shaped mandrel and cutting the non-rectangular segments from the base material comprises cutting the non-rectangular segments having a small end and a large end, wherein a ratio of the small end to the large end is substantially the same as an increase ratio of a small end of the substantially frustoconically-shaped mandrel to a large end of the substantially frustoconically-shaped mandrel.

14. The method of claim 13, further comprising storing the composite material on the backing material on a substantially frustoconical storage roller before applying the composite material to the substantially frustoconically-shaped mandrel.

15. The method of claim 12, wherein cutting the non-rectangular segments from the base material comprises cutting the non-rectangular segments such that a fiber direction of the base material is substantially parallel with an axis of the non-rectangular segments extending in a longer dimension of the non-rectangular segments.

16. The method of claim 11, further comprising trimming the backing material to form a curved sheet of the composite material.

17. The method of claim 11, further comprising applying tension to the composite material between a roller and the mandrel.

18. The method of claim 17, wherein applying the tension to the composite material between the storage roller and the mandrel comprises applying tension to the composite material through a redirect device as the composite material is applied to the mandrel.

19. A system for forming a composite structure, the system comprising:
a frame;
a mandrel having a substantially frustoconical shape including a small mandrel end and a large mandrel end defining a mandrel increase ratio, the mandrel coupled to the frame; and
a composite material roll coupled to the frame adjacent the mandrel, the material roll including a sheet of composite material, the material roll having a second substantially frustoconical shape having a small material roll end and a large material roll end, defining a material roll increase ratio, the material roll increase ratio substantially matching the mandrel increase ratio.

20. The system of claim 19, wherein the sheet of composite material comprises:
a backing material; and
at least two trapezoidal segments of composite material coupled to the backing material, a first trapezoidal segment of the at least two trapezoidal segments positioned adjacent to a second trapezoidal segment of the at least two trapezoidal segments.

21. The system of claim 19, wherein the sheet of composite material includes an inner edge having a first length and an outer edge having a second length greater than the first length of the inner edge.

22. The system of claim 21, wherein a ratio defined by the first length and the second length matches the material roll increase ratio.

23. The system of claim 19, further comprising a tensioner positioned between the material roll and the mandrel.

24. The system of claim 19, further comprising a redirect configured to apply tension to the sheet of composite material between the composite material roll and the mandrel.

25. The system of claim 19, further comprising one or more compactors configured to apply pressure to the sheet of composite material on the mandrel.

26. The system of claim 25, wherein the one or more compactors are configured to apply heat to the composite material on the mandrel.
